(19) United States
(12) Patent Application Publication
(10) Pub. No.: US 2024/0286072 A1
(43) Pub. Date: Aug. 29, 2024

(54) FILTER ELEMENT FOR FILTERING FLUID AND METHOD FOR PRODUCING FILTER ELEMENT

(71) Applicant: MANN+HUMMEL GmbH, Ludwigsburg (DE)

(72) Inventor: Andreas KAMMERMEIER, Bavaria (DE)

(21) Appl. No.: 18/581,928

(22) Filed: Feb. 20, 2024

(30) Foreign Application Priority Data
Feb. 24, 2023 (DE) 102023104591.1

(51) Int. Cl. B01D 46/52; B01D 46/00

(52) U.S. Cl. CPC B01D 46/522; B01D 46/0005

(57) ABSTRACT

A filter element for filtering a fluid has a filter medium body with a zigzag-folded filter medium. The filter medium body has a raw-side inlet surface and a clean-side outlet surface and outer edges including an angled outer edge positioned at an angle larger than 40° relative to an advancing direction of the folds of the filter medium. First adhesive traces are arranged in an unwound state of the filter medium on at least one end face of the filter medium at outer edges of the filter medium such that neighboring folds of the filter medium are bonded near end face edges of the at least one filter medium body. A second adhesive trace extends, at least in sections, adjacent to one of the first adhesive traces in a region of the angled outer edge of the filter medium body. A method for producing the filter element is provided.

### BACKGROUND OF THE INVENTION

The invention concerns a filter element for filtering a fluid, in particular air, as well as a method for producing a filter element.

U.S. Pat. No. 5,622,583 discloses a method for producing a filter insert with a zigzag-folded filter medium. The method comprises the steps: transporting the filter medium; transporting the filter medium in a transport direction, embossing folded edges of the filter medium, applying at least two glue beads on a surface of the filter medium by means of glue application devices provided with glue application nozzles, wherein the step of applying comprises moving at least one of the glue application devices transversely to a transport direction of the filter medium, and subsequently folding the filter medium.

### SUMMARY OF THE INVENTION

It is an object of the invention to provide an inexpensive filter element for filtering a fluid, in particular air.

A further object of the invention is providing a method for producing an inexpensive filter element.

The aforementioned object according to an aspect of the invention is solved by a filter element for filtering a fluid, in particular air, with at least one filter medium body with a zigzag-folded filter medium, with a raw-side inlet surface and a clean-side outlet surface, wherein first adhesive traces in an unwound state of the filter medium are arranged on at least one end face of the filter medium at outer edges of the filter medium body such that neighboring folds of the folded filter medium near their end face edges are bonded, wherein a second adhesive trace extends adjacent, in particular parallel, to the first adhesive trace at least in sections, wherein the second adhesive trace is arranged in a region of the filter medium body whose outer edge comprises an angle larger than 40°, preferably larger than 45°, particularly preferred larger than 50°, in relation to an advancing direction of folds of the filter medium sequentially following each other.

The further object is solved according to a further aspect of the invention by a method for producing a filter medium, comprising at least cutting to size an unwound filter medium; applying a first adhesive trace in the unwound state of the filter medium to at least one end face of the filter medium at outer edges of the filter medium; applying at least in sections a second adhesive trace adjacent to the first adhesive trace; folding the filter medium to a filter medium body; the second adhesive trace is applied in a region of the filter medium body whose outer edge comprises an angle larger than 40°, preferably larger than 45°, particularly preferred larger than 50°, in relation to an advancing direction of folds of the filter medium sequentially following each other.

Beneficial embodiments and advantages of the invention result from the additional claims, the description, and the drawing.

According to an aspect of the invention, a filter element for filtering a fluid, in particular air, is proposed, with at least one filter medium body with a zigzag-folded filter medium, with a raw-side inlet surface and a clean-side outlet surface. First adhesive traces in an unwound state of the filter medium are arranged on at least one end face of the filter medium at outer edges of the filter medium body in such a way that neighboring folds of the folded filter medium are bonded near their end face edges. In this context, a second adhesive trace extends adjacent, in particular parallel, to the first adhesive trace at least in sections. The second adhesive trace is arranged in a region of the filter medium body whose outer edge comprises an angle larger than 40°, preferably larger than 45°, particularly preferred larger than 50°, in relation to an advancing direction of folds of the filter medium sequentially following each other. In this way, the lateral strip sealing action of the filter medium body for such large angles can be dispensed with which would be required otherwise because a single adhesive trace carries the risk of leakages in case of such large angles.

For installation space reasons, the filter medium bodies often comprise a region whose outer edge defines an angle of, for example, larger than 40° or 45° in relation to an advancing direction of folds of the filter medium sequentially following each other. This angle is referred to also as bevel angle.

Usually, filter medium bodies of flat filters comprise an adhesive trace as an end face edge bonding for lateral sealing of the filter medium body. In regions of bevel angles of larger than 45°, the filter medium bodies are usually sealed by lateral strips because the end face edge bonding alone cannot ensure the seal-tightness in case of larger angles.

In the proposed filter element, a second, in particular parallel applied, adhesive trace is arranged as an additional end face edge bonding which enables a seal-tight bonding of the region of the filter medium body up to an angle of approximately 75°. On the one hand, this is so because more glue can be applied at almost the same location. On the other hand, overlapping of the end face edge bonding is displaced further toward the end face so that the cause for the leakage in case of a single bonding action can be circumvented.

In this manner, the restriction on using end face edge bonding for lateral sealing of the filter medium body to regions with a bevel angle of maximally 40° or 45° C. an be abolished.

In case of an unwound state, the filter medium is present as a web, not folded, of the filter medium to which an adhesive trace can be applied in a generally known manner such that, after folding of the filter medium, sections of the adhesive traces positioned between neighboring folds can contact each other.

This second end face edge bonding makes it possible to use filter medium bodies with regions with bevel angles of up to approximately 75°. In this context, an otherwise required sealing action of the filter medium body by a lateral strip can be dispensed with.

Advantageously, possible downstream work steps, for example, gluing on the lateral strip, can be dispensed with, whereby the production costs of the filter element can be significantly reduced.

According to a beneficial embodiment of the filter element, the first and the second adhesive trace can be spaced apart at a distance. In particular, in this context the first and the second adhesive trace can be arranged at a distance relative to each other of at least 1 mm, preferably at least 2 mm, particularly preferred at least 3 mm. In this manner, the adhesive traces can extend adjacent to each other and ensure a sealing action as beneficial as possible.

The first adhesive trace can be a continuous adhesive trace which is not only arranged in the region of the filter medium body whose outer edge comprises an angle larger than 40°, preferably larger than 45°, particularly preferred larger than 50°, in relation to an advancing direction of folds of the filter medium sequentially following each other but also in neighboring regions of the filter medium body whose outer edge comprises a smaller angle in relation to an advancing direction of folds of the filter medium sequentially following each other. In particular, Acontinuous≅ is to be understood as a contiguous adhesive trace, in particular applied in one piece.

According to a beneficial embodiment of the filter element, the second adhesive trace can be arranged on a side of the first adhesive trace which is facing the outer edge of the filter medium body. In this way, a beneficial sealing action of the end face edges can be achieved, in particular for large bevel angles. Alternatively, the second adhesive trace can also be arranged on a side of the first adhesive trace which is facing away from the outer edge of the filter medium body.

According to a beneficial embodiment of the filter element, at least a third adhesive trace can be arranged on the end face of the filter medium between the first adhesive traces. With this additional adhesive trace, a stabilization of the folds of the filter medium can be advantageously achieved, in particular in case of large, areally expansive filter medium bodies.

According to a beneficial embodiment of the filter element, a seal can be arranged at the outer edges of the filter medium body at the end face with the first and the second adhesive traces. In particular, in this context the outer edges of the filter medium body and the first and second adhesive traces can be enclosed with a plastic material, in particular with polyurethane, in particular by foaming or injection molding. With this seal, the sealing action of the filter element in a filter housing can be realized advantageously. In addition, enclosing the two adhesive traces by foaming or injection molding ensures a particularly reliable sealing action of the end face edges of the filter medium body.

According to a further aspect of the invention, a method for producing a filter element is proposed, comprising at least cutting to size an unwound filter medium; applying a first adhesive trace in the unwound state of the filter medium to at least one end face of the filter medium at outer edges of the filter medium; at least in sections applying a second adhesive trace adjacent to the first adhesive trace; and folding the filter medium to a filter medium body.

For installation space reasons, filter medium bodies often comprise a region whose outer edge forms an angle of, for example, larger than 40° or 45°, in relation to an advancing direction of folds of the filter medium sequentially following each other.

Usually, filter medium bodies of flat filters comprise an adhesive trace as end face edge bonding for lateral sealing action of the filter medium body. In regions with bevel angles of larger than 40° or 45°, the filter medium bodies are often sealed by lateral strips because the end face edge bonding alone cannot ensure the seal-tightness in case of larger angles.

In the proposed method, a second, in particular parallel applied, adhesive trace is arranged as an additional end face edge bonding at the filter medium body which enables a seal-tight bonding of the region of the filter medium body up to an angle of approximately 75°. On the one hand, this is so because more glue can be applied at almost the same location. On the other hand, overlapping of the end face edge bonding is displaced further toward the end face so that the cause for the leakage in case of a single bonding can be circumvented.

In this manner, the restriction on using end face edge bonding for lateral sealing of the filter medium body to regions with a bevel angle of maximally 40° or 45° C. an be abolished.

This second end face edge bonding makes it possible to use filter medium bodies with regions with bevel angles of up to approximately 75°. In this context, an otherwise required sealing action of the filter medium body with a lateral strip can be dispensed with.

Advantageously, possible downstream work steps, for example, gluing on the lateral strip, can be dispensed with, whereby the production costs of the filter element can be significantly reduced.

According to a beneficial embodiment of the method, the second adhesive trace can be applied spaced apart from the first adhesive trace. In particular, in this context the second adhesive trace can be applied at a distance of at least 1 mm, preferably at least 2 mm, particularly preferred at least 3 mm, in relation to the first adhesive trace. In this manner, the adhesive traces can be arranged adjacent to each other, whereby a sealing action as beneficial as possible can be ensured. In particular, the second adhesive trace can be applied at a distance of at most 15 mm, preferably at most 10 mm, particularly preferred at most 7 mm, in relation to the first adhesive trace.

The second adhesive trace is applied in a region of the filter medium body whose outer edge comprises an angle larger than 40°, preferably larger than 45°, particularly preferred larger than 50°, in relation to an advancing direction of folds of the filter medium sequentially following each other. In this way, the lateral strip sealing action of the filter medium body for such large angles can be dispensed with which would be required otherwise because a single adhesive trace carries the risk of leakages in case of such large angles.

According to a beneficial embodiment of the method, the second adhesive trace can be applied at a side of the first adhesive trace facing the outer edge of the filter medium body. In this way, a beneficial sealing action of the end face edges can be achieved, in particular for large bevel angles.

According to a beneficial embodiment of the method, at least a third adhesive trace can be applied to the end face of the filter medium between the first adhesive traces. With this additional adhesive trace, a stabilization of the folds of the filter medium can be advantageously achieved, in particular for large, areally expansive filter medium bodies.

According to a beneficial embodiment of the method, a seal can be applied to the outer edges of the filter medium body at the end face with the first and second adhesive traces. In particular, in this context the outer edges of the filter medium body and the first and second adhesive traces can be enclosed with a plastic material, in particular with polyurethane, in particular by foaming or injection molding. With this seal, the sealing action of the filter element in a filter housing can be advantageously realized. In addition, enclosing the two adhesive traces by foaming or injection molding ensures a particularly reliable sealing action of the end face edges of the filter medium body.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a plan view of a filter medium body of a filter element for filtering a fluid, in particular air, according to an embodiment of the invention.

FIG. 2 shows an isometric illustration of a filter element according to an embodiment of the invention from the inlet side of the fluid.

FIG. 3 shows a plan view of the filter element of FIG. 2 from the outlet side of the fluid.

FIG. 4 shows an isometric illustration of the filter element of FIG. 2 from the outlet side of the fluid.

### DESCRIPTION OF PREFERRED EMBODIMENTS

In the Figures, same or same-type components are identified with same reference characters. The Figures show only examples and are not to be understood as limiting.

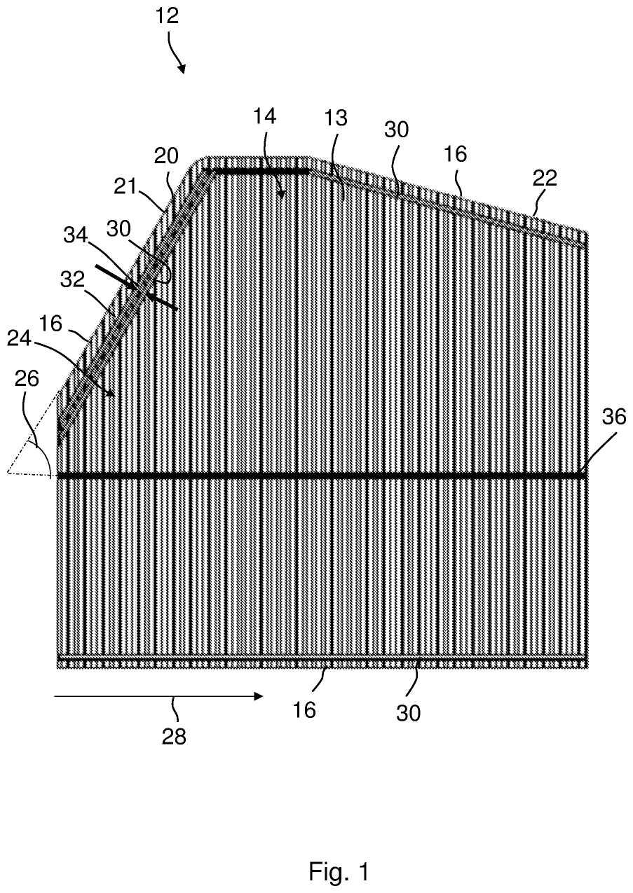

For explaining the invention, FIG. 1 shows a plan view of a filter medium body 12 of a filter element 10 for filtering a fluid, in particular air, according to an embodiment of the invention.

The filter medium body 12 comprises a zigzag-folded filter medium 13. In this context, first adhesive traces 30 in an unwound state of the filter medium 13 are arranged on at least one end face 14 of the filter medium 13 at outer edges 16 of the filter medium body 12 in such a way that neighboring folds 20 of the folded filter medium 13 are bonded near their end face edges 22. Furthermore, the filter medium body 12 comprises, at least in sections, a second adhesive trace 32 which extends adjacent, in particular parallel, to the first adhesive trace 30.

The filter medium 13 can be a nonwoven, for example.

The second adhesive trace 32 is arranged in a region 24 of the filter medium body 12 whose outer edge 16 comprises an angle 26 larger than 40°, preferably larger than 45°, particularly preferred larger than 50°, in relation to an advancing direction 28 of folds 20 of the filter medium 13 sequentially following each other. The advancing direction 28 of the folds 20 is indicated in FIG. 1 by an arrow. The angle 26 of the region 24 is indicated in FIG. 1 and amounts to approximately 75° in the illustrated embodiment.

The first and the second adhesive traces 30, 32 are spaced apart at a distance 34. In particular, the first and the second adhesive traces 30, 32 can be arranged relative to each other at a distance 34 of at least 1 mm, preferably at least 2 mm, particularly preferred at least 3 mm. In this manner, the adhesive traces 30, 32 can extend adjacent to each other, whereby a sealing action as beneficial as possible is ensured.

The second adhesive trace 32, as illustrated, can be arranged at a side of the first adhesive trace 30 which is facing the outer edge 16 of the filter medium body 12. In this way, a beneficial sealing action of the end face edges can be achieved, in particular in case of large bevel angles.

The filter medium body 12 comprises a third adhesive trace 36 at the end face 14 of the filter medium 13 between the first adhesive traces 30. With this additional adhesive trace 36, a stabilization of the folds 20 of the filter medium 13 can be achieved advantageously, in particular for large, areally expansive filter medium bodies 12.

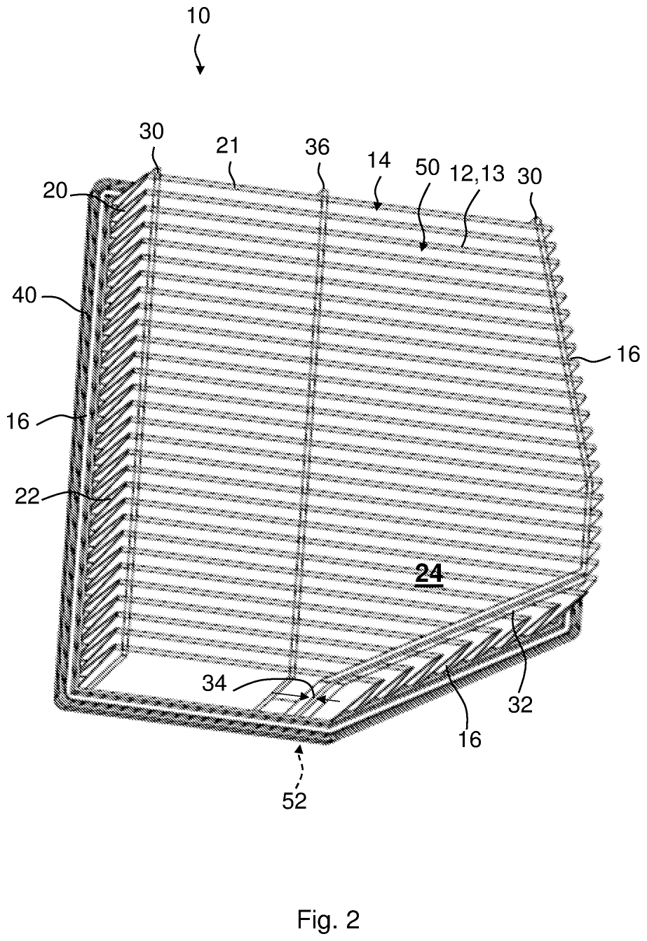

FIG. 2 shows an isometric illustration of a filter element 10 with such a filter medium body 12 according to an embodiment of the invention from the inlet side 50 of the fluid.

The filter element 10 comprises a raw-side inlet surface 50 and a clean-side outlet surface 52 for the fluid. In FIG. 2, the filter element 10 is illustrated from the raw-side inlet surface 50.

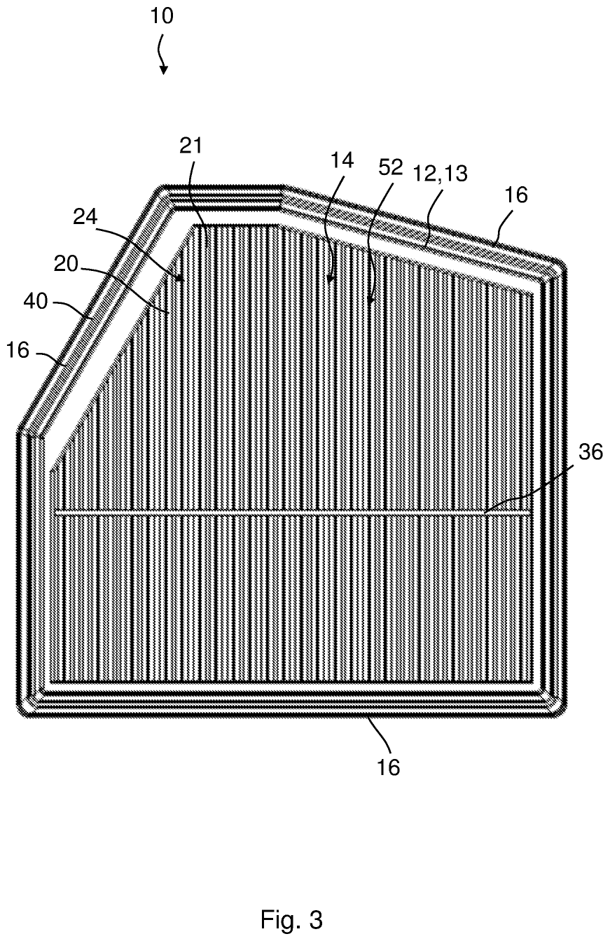

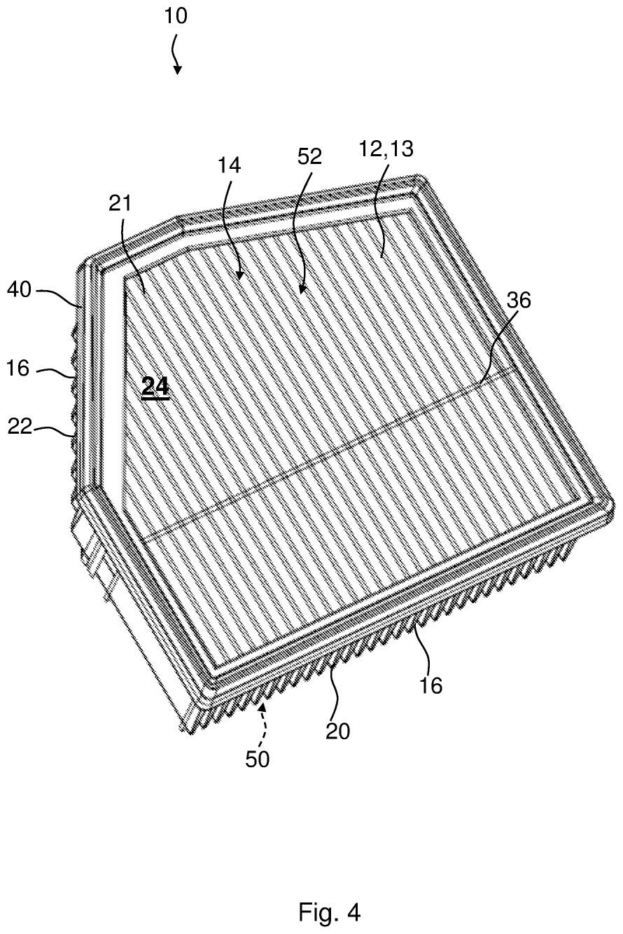

FIG. 3 shows a plan view of the filter element 10 from the outlet side 52 of the fluid, while in FIG. 4 an isometric illustration of the filter element 10 from the outlet side 52 of the fluid is illustrated.

The filter element 10 comprises a circumferentially extending seal 40 which is arranged at the outer edges 16 of the filter medium body 12 at the end face 14 with the first and second adhesive traces 30, 32.

As can be seen in particular in FIGS. 3 and 4, in this context the outer edges 16 of the filter medium body 12 and the first and second adhesive traces 30, 32 can be enclosed with a plastic material, in particular with polyurethane, in particular by foaming or injection molding.

With such a seal 40, the sealing action of the filter element 10 in a filter housing can be advantageously realized. In addition, enclosing the two adhesive traces 30, 32 by foaming or injection molding ensures a particularly reliable sealing action of the end face edges 22 of the filter medium body 12.

### REFERENCE CHARACTERS

10 filter element
12 filter medium body
13 filter medium
14 end face
16 outer edge
20 fold
21 fold tip
22 end face edge
24 region
26 angle
28 advancing direction
30 first adhesive trace
32 second adhesive trace
34 distance
36 third adhesive trace
40 seal
50 inlet surface
52 outlet surface

What is claimed is:

1. A filter element for filtering a fluid, the filter element comprising:
at least one filter medium body comprising a filter medium folded in a zigzag shape to folds, the at least one filter medium body comprising a raw-side inlet surface and a clean-side outlet surface, wherein the at least one filter medium body comprises outer edges including an angled outer edge positioned at an angle larger than 40° in relation to an advancing direction of the folds of the filter medium sequentially following each other;
first adhesive traces arranged in an unwound state of the filter medium on at least one end face of the filter medium at outer edges of the filter medium such that respective neighboring folds of the filter medium are bonded near end face edges of the at least one filter medium body;
a second adhesive trace extending, at least in sections, adjacent to one of the first adhesive traces in a region of the angled outer edge of the at least one filter medium body.

2. The filter element according to claim 1, wherein said one of the first adhesive traces and the second adhesive trace are spaced apart at a distance from each other and extend parallel to each other.

3. The filter element according to claim 2, wherein the distance is at least 1 mm.

4. The filter element according to claim 1, wherein the second adhesive trace is arranged on a side of said one of the first adhesive traces, wherein said side is facing the angled outer edge of the at least one filter medium body.

5. The filter element according to claim 1, wherein at least a third adhesive trace is arranged on the at least end face of the filter medium and is located between the first adhesive traces.

6. The filter element according to claim 1, further comprising a seal arranged at the outer edges of the at least one filter medium body at the at least one end face of the filter medium with the first adhesive traces and the second adhesive trace.

7. The filter element according to claim 6, wherein the outer edges of the at least one filter medium body and the first adhesive traces and the second adhesive trace are enclosed with a plastic material.

8. The filter element according to claim 7, wherein the plastic material is polyurethane and wherein the outer edges of the at least one filter medium body and the first adhesive traces and the second adhesive trace are enclosed by foaming or injection molding the polyurethane thereon.

9. A method for producing a filter element according to claim 1, the method comprising:
cutting to size the unwound filter medium;
applying the first adhesive traces in the unwound state of the filter medium to the at least one end face of the filter medium at the outer edges of the filter medium;
applying, at least in sections, the second adhesive trace adjacent to one of the first adhesive traces such that, after folding of the filter medium to the filter medium body, the second adhesive trace is arranged in the region of the angled outer edge of the filter medium body positioned at an angle larger than 40° in relation to an advancing direction of the folds of the filter medium;
subsequently folding the filter medium to the filter medium body.

10. The method according to claim 9, further comprising spacing apart the second adhesive trace from said one of the first adhesive traces.

11. The method according to claim 10, further comprising spacing apart the second adhesive trace at a distance of at least 1 mm relative to said one of the first adhesive traces.

12. The method according to claim 9, further comprising arranging the second adhesive trace at a side of said one of the first adhesive traces, said side facing the angled outer edge of the filter medium body.

13. The method according to claim 9, further comprising applying at least a third adhesive trace to the at least one end face of the filter medium between the first adhesive traces.

14. The method according to claim 9, further comprising applying a seal to the outer edges of the filter medium body at the at least one end face with the first and second adhesive traces.

15. The method according to claim 9, further comprising forming a seal at the filter medium body by enclosing the outer edges of the filter medium body and the first and second adhesive traces with a plastic material.

16. The method according to claim 15, wherein the plastic material is polyurethane, further comprising foaming or injection molding the polyurethane to the outer edges of the filter medium body and to the first and second adhesive traces.
